(19) United States
(12) Patent Application Publication
(10) Pub. No.: US 2013/0299434 A1
(43) Pub. Date: Nov. 14, 2013

(54) Removing Ammonia From Water

(71) Applicants: Jose Sanchez, Los Angeles, CA (US); Andrew Davies, (US); Nicholas Eckleberry, Los Angeles, CA (US)

(72) Inventors: Nicholas Eckelberry, Los Angeles, CA (US); Jose Sanchez, Los Angeles, CA (US); Andrew Davis, Los Angeles, CA (US)

(21) Appl. No.: 13/942,348

(22) Filed: Jul. 15, 2013

Related U.S. Application Data
(63) Continuation-in-part of application No. 13/872,044, filed on Apr. 26, 2013.
Application No. 13/872,044 is a continuation-in-part of application No. 13/865,087, filed on Apr. 17, 2013.
Application No. 13/865,087 is a continuation-in-part of application No. 13/753,484, filed on Jan. 29, 2013.
(60) Provisional application No. 61/592,522, filed on Jan. 30, 2012.
(60) Provisional application No. 61/625,463, filed on Apr. 17, 2012.

(51) Int. Cl. C02F 1/467; C02F 1/76

(52) U.S. Cl. CPC C02F 1/4674; C02F 1/76
USPC 210/739; 210/192; 210/96.1; 210/754

(57) ABSTRACT

A system for removing ammonia from wastewater includes a series of interconnected reactor tubes that each comprise an outer cathode and an inner cathode that is centrally positioned within the outer cathode to form a spacing of between 3 mm and 10 mm through which wastewater may flow. At least one of the reactor tubes includes an inner cathode having a MMO coating. Hypochlorite or another chlorine based element can be supplied to wastewater prior to passing through the reactor tubes. The presence of the hypochlorite within the wastewater and the generation of chlorine by the MMO coated cathode result in an increased level of hypochlorite being present in the wastewater which speeds the breakdown of ammonia. A portion of the wastewater processed through the reactor tubes can be diverted through a feedback path to the input to the reactor tubes to increase the amount of hypochlorite present in the unprocessed wastewater.

### CROSS-REFERENCE TO RELATED APPLICATIONS

This application is a continuation-in-part of U.S. patent application Ser. No. 13/872,044 filed on Apr. 26, 2013, titled Producing Algae Biomass Having Reduced Concentration Of Contaminants, which is a continuation-in-part of U.S. patent application Ser. No. 13/865,087 filed Apr. 17, 2013, titled Harvesting And Dewatering Algae Using A Two- Stage Process, which is a continuation-in-part of U.S. patent application Ser. No. 13/753,484, filed Jan. 29, 2013, titled Systems And Methods For Harvesting And Dewatering Algae, which claims priority to U.S. Provisional Patent Application No. 61/592,522, filed Jan. 30, 2012, titled Systems And Methods For Harvesting And Dewatering Algae.

U.S. patent application Ser. No. 13/865,087 also claims priority to U.S. Provisional Patent Application No. 61/625,463, filed Apr. 17, 2012, titled Solute Extraction From An Aqueous Medium Using A Modular Device, and to U.S. Provisional Patent Application No. 61/649,083, filed May 28, 2012, titled Modular Systems And Methods For Extracting A Contaminant From A Solution. This application claims the benefit of these two provisional applications.

The disclosure of each of the applications to which the present application claims priority are incorporated by reference.

### BACKGROUND

Existing systems of wastewater treatment are limited to treating wastewater with bacterial digestion, oxidation, settling, and disinfection usually using chlorination. More advanced methods, such as ozone and ultraviolet radiation, also are used to treat water and wastewater.

Ammonium ions are a toxic waste product of the metabolism in animals. In fish and aquatic invertebrates, it is excreted directly into the water. Ammonia removal has attracted much attention in the past due to the need for the control of nitrogen nutrients to prevent eutrophication in a variety of water bodies. However, present technologies such as biological nitrogen removal, air stripping and ion exchange have several constraints including their inability to reduce ammonia to much lower levels, pollutant transfer into other media, and higher cost, among others.

Electrochemical processing has been explored as an alternative to existing methods for removing ammonia from wastewater. The successful use of electrochemical processing to remove ammonia has required a high concentration of chlorine anions (Cl⁻), whether initially present in the wastewater or added to the wastewater. When Cl⁻ is subject to an electric field, an electrochemical reaction converts it into the oxidizing agent hypochlorous acid (HOCl).

The removal mechanism of ammonia in the electrochemical process is poorly understood in terms of the oxidation route and reaction kinetics. A direct oxidation of ammonia occurs at electrode-liquid interfaces of the anode. The removal of ammonia also takes place through an indirect oxidation route by both hydroxyl radicals and HOCl formed in the electrochemical processes.

The chemical removal of ammonia compounds is achieved in stages. This process is referred to as Breakpoint chlorination and is illustrated in FIG. 1. The graph in FIG. 1 illustrates what happens to chlorine when it is added to water (whether as a chlorine gas or a hypochlorite). When chlorine enters water, it begins to react with compounds found in the water including reducing agents such as hydrogen sulfide and ferrous irons. These initial reactions produce chloride ions or hydrochloric acid which have no disinfecting properties. FIG. 1 illustrates this stage between points 1 and 2. As shown, there is no chlorine residual during this first stage.

As more chlorine is added to the water, the chlorine reacts with organics and ammonia naturally found in the water. During this second stage, illustrated as occurring between points 2 and 3, the reactions produce chloramines and therefore the chlorine residual increases.

In a third stage, between points 3 and 4, as more chlorine is added, the chlorine will react to break down most of the chloramines in the water that were produced during the second stage or otherwise present in the water. These reactions consume the chlorine thereby lowering the chlorine residual in the water.

Finally, at point 4, as more chlorine is added, the water reaches the breakpoint. The breakpoint is the point at which the chlorine demand has been totally satisfied (i.e. the chlorine has reacted with all reducing agents, organics, and ammonia in the water). When more chlorine is added past the breakpoint, the chlorine reacts with water and forms hypochlorous acid in direct proportion to the amount of chlorine added resulting in an increasing amount of chlorine residual.

There are various important factors in this breakpoint chlorination process that determine whether the process can be implemented in an efficient and satisfactory manner. These factors include: (1) the time it takes to reach the breakpoint; (2) the amount of chlorine that must be added to create an appropriate chlorine residual level; (3) the energy costs associated with the process; (4) the scalability of the process; and (5) the adaptability of the process to different types of water (e.g. fresh, city, brine, sea, and frac water).

In some prior art approaches (see, e.g. U.S. Pat. No. 7,736,776 to Spielman, et al.; European Patent No.: 1,400,494 to Enpar Technologies, Inc.), various enhancements have been used to accomplish breakpoint chlorination with electrolysis. However, the systems proposed in these prior art approaches have limited flow rates due to, for example, constrictions generated by passing the flow through planar positioned electrodes, or requirements that additional pretreatment tanks be used. As a result, these prior art system are impractical for use at an industrial level where space and flow rates are critical.

### BRIEF SUMMARY

The present invention is generally directed to a system for reducing or eliminating ammonia from water using a series of reaction tubes that employ mixed metal oxide annodes. Each reaction tube can include an outer cathode and an inner anode, which are closely spaced to enhance the creation of chlorine residual (e.g. hypochlorite) within the reaction tubes. Additionally, a feedback path can be employed after the series of reaction tubes to route a portion of the water back to the input to the reaction tubes. This feedback path increases the amount of chlorine residual available in the water as it passes through the reaction tubes.

In some embodiments, water can be fed into the series of reaction tubes using an impeller pump which increases the interaction of the chlorine residual with the ammonia in the water by creating micron bubbles through cavitation. A mixing zone can also be positioned after the impeller pump to enhance the mixing of the micron bubbles within the water prior to being input into the series of reaction tubes. The presence of the micron bubbles containing the chlorine residual increases the surface area exposed to the ammonia thereby increasing the rate at which the ammonia is broken down. Accordingly, ammonia can be eliminated in a quick and energy efficient manner enabling high flow rates. In this way, the present invention can be used in virtually any industry as a practical means for eliminating ammonia from wastewater.

In one embodiment, the present invention is implemented as a system for removing ammonia from wastewater. The system includes a plurality of reactor tubes connected in series. Each reactor tube comprises an outer cathode and an inner anode being positioned centrally within the outer cathode such that a spacing between 3 mm and 10 mm exists between the outer surface of the anode and the inner surface of the cathode. At least one of the reactor tubes contains an inner anode having a mixed metal oxide (MMO) coating.

The system also includes a pump connected to an input of the plurality of reactor tubes. The pump receives unprocessed wastewater containing ammonia from a wastewater source and pumps the unprocessed wastewater into and through the series of reactor tubes.

The system also includes a power supply for supplying a voltage differential to the cathode and the anode in each reactor tube thereby causing the generation of chlorine based elements within the unprocessed wastewater as the unprocessed wastewater passes through the reactor tubes. The chlorine based elements interact with the ammonia in the unprocessed wastewater to eliminate the ammonia thereby producing processed wastewater containing a reduced level of ammonia.

The system also includes a feedback path that diverts a portion of the processed wastewater that exits an output of the series of reactor tubes back to an input of the pump such that chlorine based elements contained in the processed wastewater are mixed with unprocessed wastewater to increase the level of chlorine based elements available in the unprocessed wastewater as the unprocessed wastewater passes through the reactor tubes.

In another embodiment, the present invention is implemented as a method for removing ammonia from wastewater. Unprocessed wastewater is received at a pump connected to a series of interconnected reactor tubes. Each reactor tube comprises an outer cathode and an inner anode being positioned centrally within the outer cathode such that a spacing between 3 mm and 10 mm exists between the outer surface of the cathode and the inner surface of the anode. At least one of the reactor tubes contains an inner anode having a mixed metal oxide (MMO) coating.

Chlorine based elements are injected into the unprocessed wastewater. The unprocessed wastewater containing the chlorine based elements is then pumped through the reactor tubes. A voltage differential is applied to the anode and cathode of each reactor tube to cause an interaction between the MMO coating and the chlorine based elements which produces additional chlorine based elements. The chlorine based elements interact with the ammonia to reduce the amounts of ammonia in the wastewater thereby producing processed wastewater.

A portion of the processed wastewater is then diverted from an output of the series of interconnected reactor tubes. The portion of the processed wastewater is diverted to an input to the pump such that chlorine based elements contained in the portion of the processed wastewater are supplied into unprocessed wastewater that is pumped into the series of interconnected reactor tubes.

In another embodiment, the present invention is implemented as a system for removing ammonia from wastewater. The system includes a plurality of reactor tubes connected in series. Each reactor tube comprises an outer cathode and an inner anode being positioned centrally within the outer anode such that a spacing between 3 mm and 10 mm exists between the outer surface of the anode and the inner surface of the cathode. At least one of the reactor tubes contains an inner anode having a mixed metal oxide (MMO) coating.

The system also includes a hypochlorite source for injecting hypochlorite into unprocessed wastewater containing ammonia.

The system also includes a pump connected to an input of the plurality of reactor tubes. The pump receives the unprocessed wastewater and pumps the unprocessed wastewater into and through the series of reactor tubes. The pump causes cavitation to occur within the unprocessed wastewater which increases the mixing of the hypochlorite within the unprocessed wastewater.

The system also includes a power supply for supplying a voltage differential to the cathode and the anode in each reactor tube. The voltage differential causes the release of chlorine from the at least one MMO coated inner anode that interacts with the hypochlorite to produce additional hypochlorite. The hypochlorite interacts with the ammonia in the unprocessed wastewater to eliminate the ammonia thereby producing processed wastewater containing a reduced level of ammonia.

The system also includes a feedback path that diverts a portion of the processed wastewater that exits an output of the series of reactor tubes back to an input of the pump such that hypochlorite contained in the processed wastewater is mixed with unprocessed wastewater to increase the level of hypochlorite available in the unprocessed wastewater as the unprocessed wastewater passes through the reactor tubes.

This summary is provided to introduce a selection of concepts in a simplified form that are further described below in the Detailed Description. This Summary is not intended to identify key features or essential features of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts a graph of the breakpoint chlorination process;

FIG. 2 illustrates an example system for removing ammonia from wastewater using a series of MMO anodes;

FIG. 3A illustrates a cross-sectional front view of a reactor tube containing an inner anode centered between an outer cathode;

FIG. 3B illustrates a cross-sectional side view of the reactor tube;

FIGS. 4 illustrate a flow-splitting valve used to provide a feedback path for diverting processed wastewater to be mixed with unprocessed wastewater;

FIG. 5 illustrates another example of a system for removing ammonia from wastewater using a series of MMO anodes; and

FIG. 6A-6D illustrate various three-dimensional views of another example of a system for removing ammonia from wastewater using a series of MMO anodes.

### DETAILED DESCRIPTION

In U.S. patent application Ser. No. 13/872,044 as well as in U.S. patent application Ser. No. 13/865,097 to which this application claims priority, embodiments were disclosed for removing ammonia from wastewater using electrodes made of a titanium ruthenium alloy. The present application expounds on this concept and describes a system which employs mixed metal oxide anodes (e.g. titanium core anodes having a coating of a metal in the platinum family such as ruthenium or iridium) to enhance the generation of hypochlorite for breaking down the ammonia.

The prior applications to which this application claims priority primarily describe a two-stage approach for harvesting algae. This two-stage approach includes a first stage flocculation tank which employs electrodes. In the current application, reactor tubes similar to the flocculation tank described in these prior applications are employed in series to generate hypochlorite for breaking down ammonia in wastewater flowed through the reactor tubes. For the sake of brevity, the discussion of the two-stage approach is omitted from the description in this application in lieu of a specific description of how the reactor tubes can be configured to optimize ammonia removal in a quick manner.

The present invention is generally directed to a system for reducing or eliminating ammonia from water using a series of reaction tubes that employ mixed metal oxide anodes. Each reaction tube can include an outer anode and an inner anode which are closely spaced to enhance the creation of chlorine residual (e.g. hypochlorite) within the reaction tubes. Additionally, a feedback path can be employed after the series of reaction tubes to route a portion of the water back to the input to the reaction tubes. This feedback path increases the amount of chlorine residual available in the water as it passes through the reaction tubes.

In some embodiments, water can be fed into the series of reaction tubes using an impeller pump which increases the interaction of the chlorine residual with the ammonia in the water by creating micron bubbles through cavitation. A mixing zone can also be positioned after the impeller pump to enhance the mixing of the micron bubbles within the water prior to being input into the series of reaction tubes. The presence of the micron bubbles containing the chlorine residual increases the surface area exposed to the ammonia thereby increasing the rate at which the ammonia is broken down. Accordingly, ammonia can be eliminated in a quick and energy efficient manner enabling high flow rates. In this way, the present invention can be used in virtually any industry as a practical means for eliminating ammonia from wastewater.

In one embodiment, the present invention is implemented as a system for removing ammonia from wastewater. The system includes a plurality of reactor tubes connected in series. Each reactor tube comprises an outer anode and an inner anode being positioned centrally within the outer anode such that a spacing between 3 mm and 10 mm exists between the outer surface of the anode and the inner surface of the cathode. At least one of the reactor tubes contains an inner anode having a mixed metal oxide (MMO) coating.

The system also includes a pump connected to an input of the plurality of reactor tubes. The pump receives unprocessed wastewater containing ammonia from a wastewater source and pumps the unprocessed wastewater into and through the series of reactor tubes.

The system also includes a power supply for supplying a voltage differential to the anode and the anode in each reactor tube thereby causing the generation of chlorine based elements within the unprocessed wastewater as the unprocessed wastewater passes through the reactor tubes. The chlorine based elements interact with the ammonia in the unprocessed wastewater to eliminate the ammonia thereby producing processed wastewater containing a reduced level of ammonia.

The system also includes a feedback path that diverts a portion of the processed wastewater that exits an output of the series of reactor tubes back to an input of the pump such that chlorine based elements contained in the processed wastewater are mixed with unprocessed wastewater to increase the level of chlorine based elements available in the unprocessed wastewater as the unprocessed wastewater passes through the reactor tubes.

In another embodiment, the present invention is implemented as a method for removing ammonia from wastewater. Unprocessed wastewater is received at a pump connected to a series of interconnected reactor tubes. Each reactor tube comprises an outer cathode and an inner anode being positioned centrally within the outer cathode such that a spacing between 3 mm and 10 mm exists between the outer surface of the anode and the inner surface of the cathode. At least one of the reactor tubes contains an inner anode having a mixed metal oxide (MMO) coating.

Chlorine based elements are injected into the unprocessed wastewater. The unprocessed wastewater containing the chlorine based elements is then pumped through the reactor tubes. A voltage differential is applied to the anode and cathode of each reactor tube to cause an interaction between the MMO coating and the chlorine based elements which produces additional chlorine based elements. The chlorine based elements interact with the ammonia to reduce the amounts of ammonia in the wastewater thereby producing processed wastewater.

A portion of the processed wastewater is then diverted from an output of the series of interconnected reactor tubes. The portion of the processed wastewater is diverted to an input to the pump such that chlorine based elements contained in the portion of the processed wastewater are supplied into unprocessed wastewater that is pumped into the series of interconnected reactor tubes.

In another embodiment, the present invention is implemented as a system for removing ammonia from wastewater. The system includes a plurality of reactor tubes connected in series. Each reactor tube comprises an outer cathode and an inner anode being positioned centrally within the outer cathode such that a spacing between 3 mm and 10 mm exists between the outer surface of the anode and the inner surface of the cathode. At least one of the reactor tubes contains an inner anode having a mixed metal oxide (MMO) coating.

The system also includes a hypochlorite source for injecting hypochlorite into unprocessed wastewater containing ammonia.

The system also includes a pump connected to an input of the plurality of reactor tubes. The pump receives the unprocessed wastewater and pumps the unprocessed wastewater into and through the series of reactor tubes. The pump causes cavitation to occur within the unprocessed wastewater which increases the mixing of the hypochlorite within the unprocessed wastewater.

The system also includes a power supply for supplying a voltage differential to the anode and the cathode in each reactor tube. The voltage differential causes the release of chlorine from the at least one MMO coated inner anode that interacts with the hypochlorite to produce additional hypochlorite. The hypochlorite interacts with the ammonia in the unprocessed wastewater to eliminate the ammonia thereby producing processed wastewater containing a reduced level of ammonia.

The system also includes a feedback path that diverts a portion of the processed wastewater that exits an output of the series of reactor tubes back to an input of the pump such that hypochlorite contained in the processed wastewater is mixed with unprocessed wastewater to increase the level of hypochlorite available in the unprocessed wastewater as the unprocessed wastewater passes through the reactor tubes.

System for Eliminating Ammonia from Wastewater

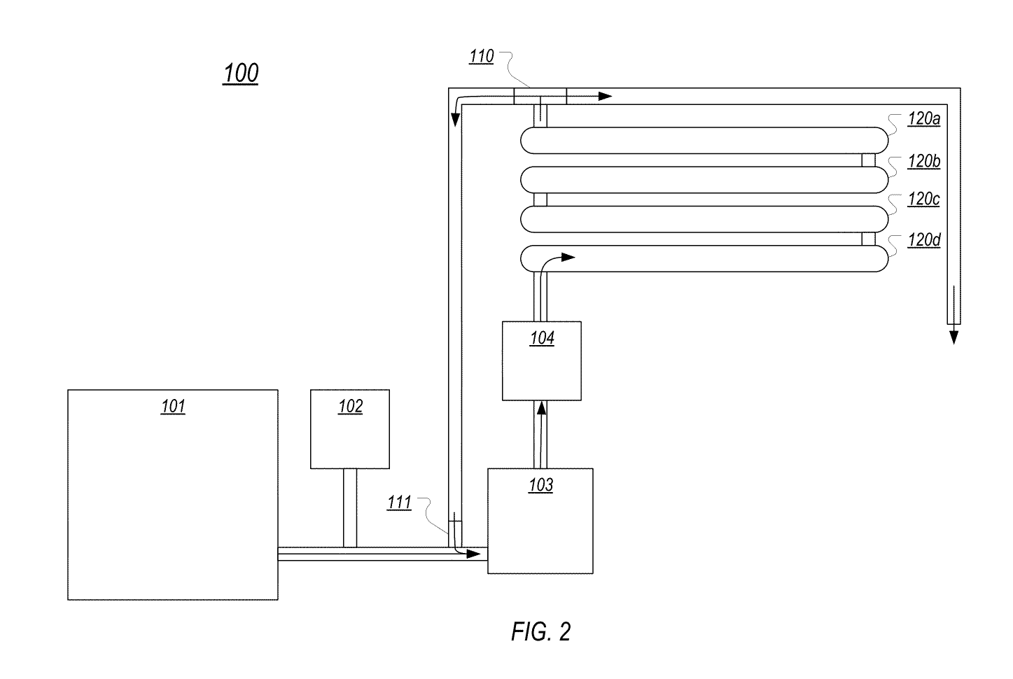

FIG. 2 illustrates an example system 100 that can be used to remove or reduce ammonia in a wastewater stream. System 100 includes a wastewater source 101 that supplies the wastewater containing ammonia. Wastewater source 101 can be any source of wastewater including ponds, streams, industrial plants, fish farms or suppliers, etc. The wastewater is fed into an impeller pump 103 which pumps the wastewater into a mixing area 104 and then through a series of reactor tubes 120a-120d (which will generally be identified with 120). Although four reactor tubes are shown in system 100, other numbers of reactor tubes can be used to accomplish a desired level of ammonia removal.

If the wastewater does not have a sufficient level of chlorine, a hypochlorite source 102 can supply hypochlorite (CIO⁻) to the wastewater stream prior to impeller pump 103. Although hypochlorite is primarily described as the source of chlorine that can be supplied to unprocessed water, other chlorine sources (or chlorine based elements) can also be used Impeller pump 103 naturally causes cavitation in the wastewater which creates numerous micron bubbles containing hypochlorite. The mixing of these micron bubbles in the wastewater is increased within mixing area 104. Mixing area 104 may be any portion of the path between impeller pump 103 and the first reactor tube (e.g. reactor tube 120d). For example, mixing area 104 can be a tank or other container positioned inline between the two components or can simply be a length of the pipe connecting the two components. This mixing of the micron bubbles increases the rate of interaction of the hypochlorite and the ammonia as well as the rate of interaction of the hypochlorite and other chlorine based elements with the anodes.

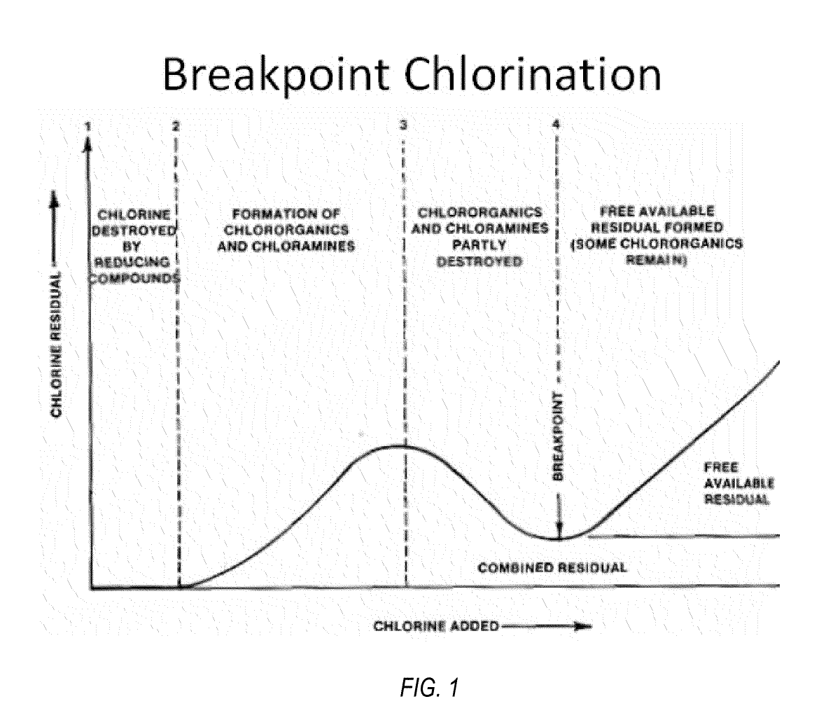

Each reactor tube 120 is comprised of an outer cathode forming the tube shape and an inner anode positioned centrally within the tube. In some embodiments, the outer cathode can be comprised of stainless steel and the inner anode can be comprised of a mixed metal oxide (MMO). In this specification MMO refers to an oxide comprised of metals in the platinum family including, but not limited to, iridium and ruthenium. In one example, a anode can be comprised of a titanium core with a MMO coating. When a voltage is applied to the MMO anode in the presence of ammonia and other chlorine based elements, hypochlorite is produced. Accordingly, the combination of the production of hypochlorite via electrolysis and the increased interaction due to the mixing of the micron bubbles in the wastewater speeds the breakpoint chlorination process depicted in FIG. 1. In other words, the time required to pass from point 1 to point 4 in FIG. 1 is increased by producing more chlorine residual (i.e. hypochlorite) and by increasing the rate of interaction of this chlorine residual with the ammonia. Therefore, the present invention can remove ammonia at a quicker rate and using less energy than in prior approaches allowing the present invention to be used to treat large amounts of wastewater quickly and efficiently.

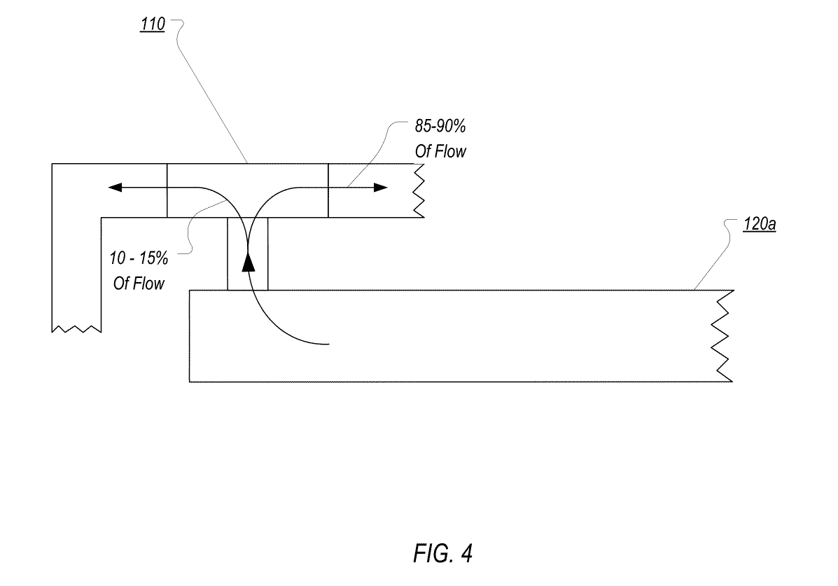

FIG. 2 also shows that system 200 includes a feedback loop comprised of a flow-splitting valve 110 and a one-way valve 111. Flow-splitting valve 110 causes a portion of the processed wastewater to be returned back to the input to impeller pump 103. In some embodiments, this portion can be 10-15% of the wastewater as shown in FIG. 4. However, any desired amount can be diverted back through the feedback loop. One-way valve 111 can prevent the unprocessed wastewater from flowing back into the feedback loop.

Because the processed wastewater contains an amount of residual hypochlorite (e.g. as shown by the rising curve after point 4 in FIG. 1), a portion of the processed wastewater can be returned to act as an additional source of hypochlorite. In this way, the amount of hypochlorite available within the wastewater passing through reactor tubes 120 can be increased without requiring the additional input of hypochlorite (e.g. via hypochlorite source 102). In other words, by returning a portion of the processed wastewater through the feedback path, the amount of hypochlorite can be gradually increased further increasing the speed at which the ammonia is removed.

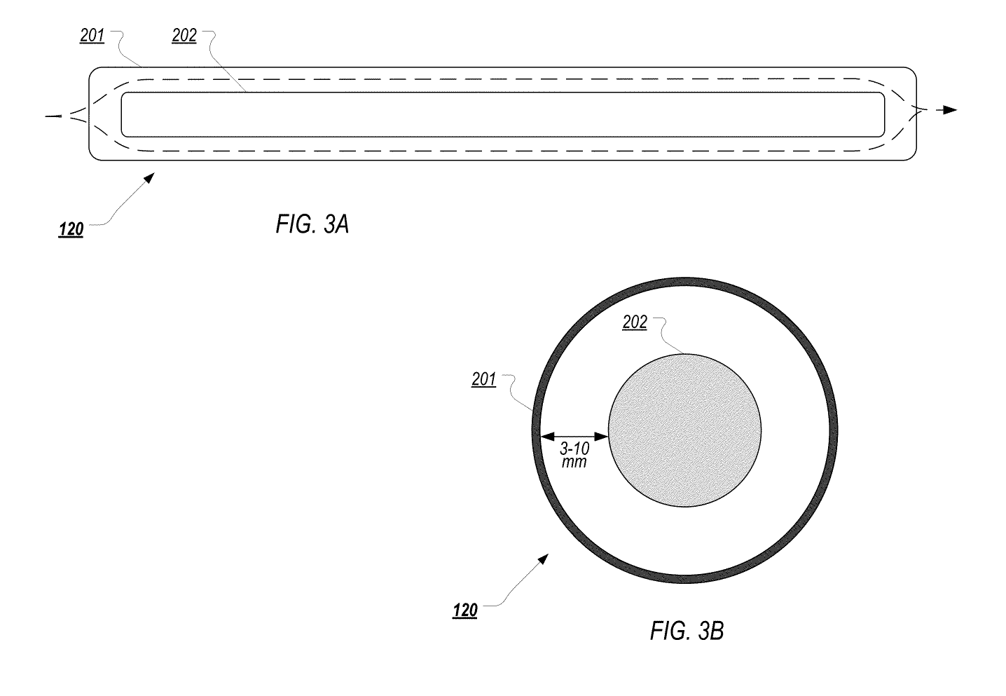

FIGS. 3A and 3B illustrate a cross-sectional front and side view respectively of a reactor tube 120. As shown in FIG. 3A, an inner anode 202 is centrally positioned within an outer cathode 201 to create a narrow pathway around the circumference of anode 202 through which the wastewater can flow (as indicated by the arrow). Inner anode 202 is coated with a MMO.

As shown in FIG. 3B, in some embodiments, the spacing between cathode 201 and anode 202 can be between 3 and 10 mm with an optimal exact spacing being dependent on the conductivity of the wastewater. A spacing within the 3-10 mm range has proven to be optimal for the creation of hypochlorite via electrolysis within wastewater containing ammonia. Specifically, with this spacing, when an electric current flows through the MMO coated anode 202, hypochlorite is generated from the reaction of elements released from the MMO coated anode 202 and elements in the wastewater such as chlorine, brine, chloramines, calcium chloride, or any other chloride salt. In cases where such elements are not sufficiently present in the wastewater prior to processing, hypochlorite (or another chlorine based element) can be added via hypochlorite source 102 to ensure that sufficient hypochlorite is generated during electrolysis. However, if sufficient chlorine based elements are present in the wastewater prior to processing, no hypochlorite may need to be added.

As noted, the presence of hypochlorite in the wastewater can increase the production of additional hypochlorite during electrolysis. Accordingly, by returning a portion of the wastewater post electrolysis, an additional amount of hypochlorite is continuously added into the process without requiring an external source of hypochlorite. This allows for the buildup of hypochlorite present within the reactor tubes 120 thereby increasing the speed at which ammonia is eliminated.

As also noted, impeller pump 103, which has a natural propensity to cause cavitation, generates micron bubbles of hypochlorite (and generally micron bubbles of oxygen and hydrogen as well). The micron bubbles blend with the wastewater enhancing the interaction of the hypochlorite with the ammonia as well as the interaction of the hypochlorite with the MMO coated anode 202. This results in an increased rate of ammonia breakdown due to both the increased interaction between the hypochlorite and the ammonia and to the increased production of additional hypochlorite through the interaction between the hypochlorite and the MMO coated anode 202. In some tests, it has been found that a flow rate of thirty seconds or less (i.e. the wastewater flows through the series of reactor tubes 120 in thirty seconds or less) is sufficient to eliminate ammonia.

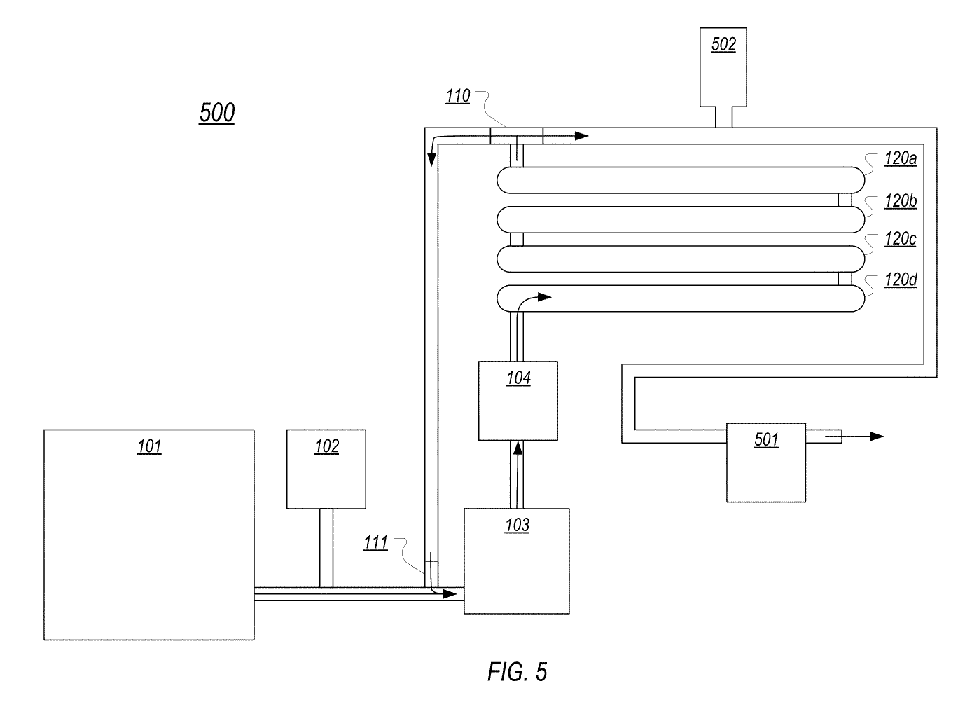

In some embodiments of the invention, the ammonia breakdown process can be automated by monitoring the oxidation reduction potential (ORP) of the wastewater. FIG. 5 illustrates another embodiment of a system 500 that includes an ORP meter 502 for monitoring the ORP of the wastewater after the wastewater passes through the series of reactor tubes 120. It has been determined that when breakpoint chlorination occurs, the ORP of the wastewater is around 750 mV. By using the ORP metric, a system can be tuned to process wastewater at a desired rate. For example, the ORP of the wastewater can be measured prior to testing (e.g. using an ORP meter (not shown) positioned upstream from the series of reactor tubes 120 such as in wastewater source 101 or in the flow path of system 500) to identify a relative amount of ammonia in the wastewater. Based on this initial ORP and a desired time for eliminating the ammonia from the wastewater, it can be determined how much hypochlorite (or other chlorine based element) must be added to the wastewater (e.g. via hypochlorite source 102) to achieve ammonia elimination in the desired time.

Similarly, ORP readings can be taken during processing to determine if the rate at which hypochlorite is added should be adjusted. For example, it can be determined from the ORP reading whether too much hypochlorite is being added (e.g. when the processed wastewater contains an excess amount of hypochlorite), and if so, the rate at which hypochlorite is being added can be reduced to conserve hypochlorite and/or to minimize the amount of free hypochlorite in the treated wastewater. Similarly adjustments could be made to increase the amount of hypochlorite added (e.g. when the ORP reading of the processed wastewater is below 750 mV).

As also shown in FIG. 5, in some embodiments of the invention, one or more post-processing filters 501 can be included to remove the chlorine (e.g. hypochlorite) from the processed wastewater. Filters 501 can include activated carbon filters, clay filters, or mineral filters such as Zeolite or Diatomaceous earth filters. For example, in some embodiments, one or more granular activated carbon (GAC) filters and/or one or more copper-zinc based filters can be used.

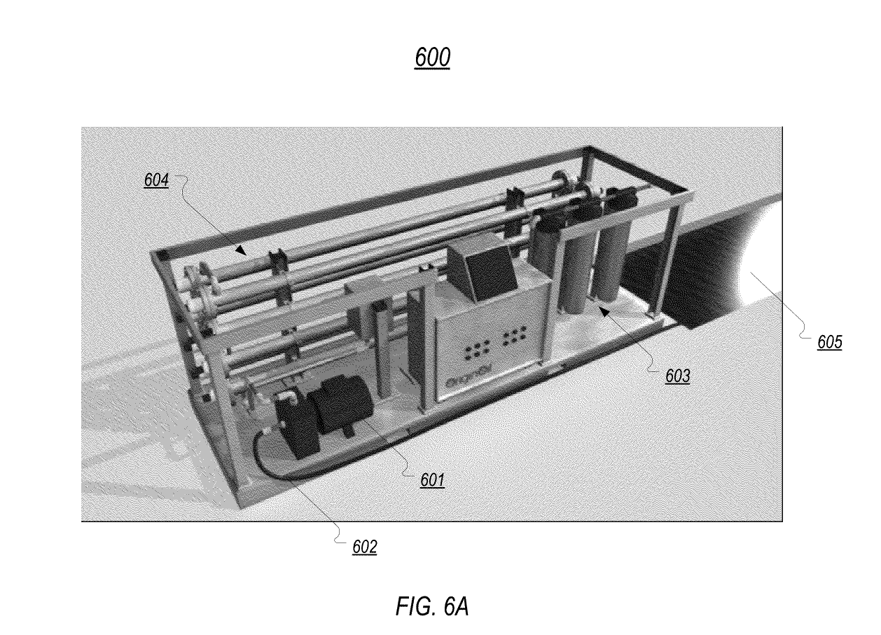

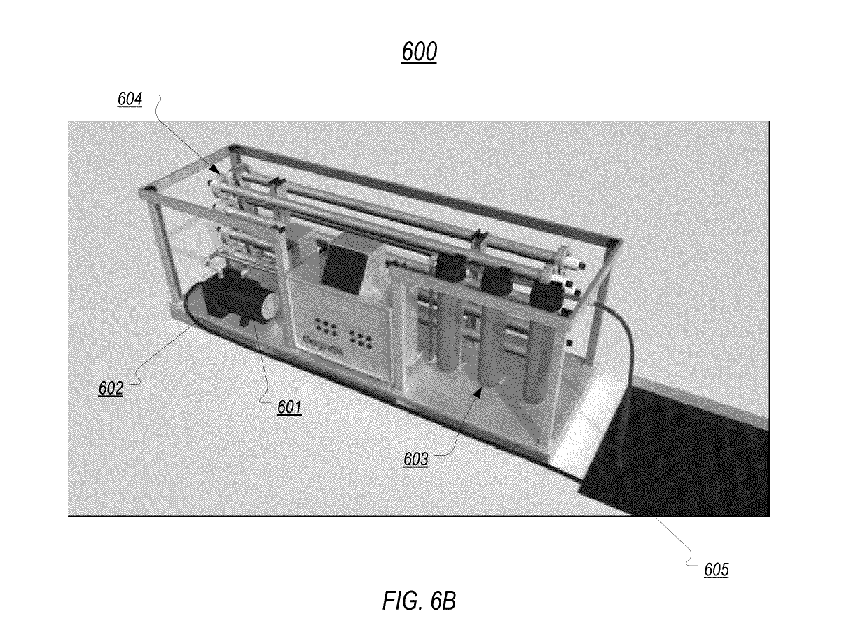

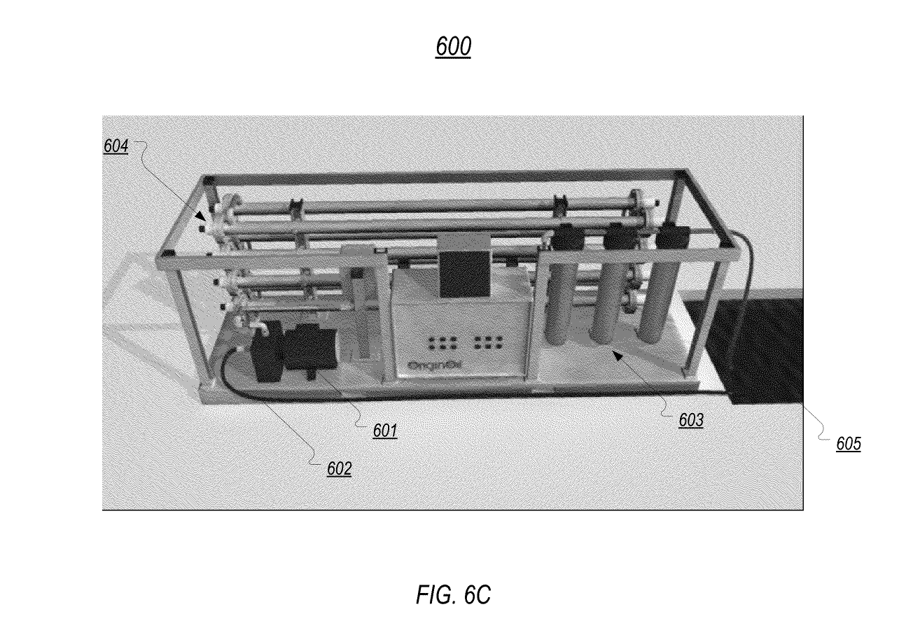

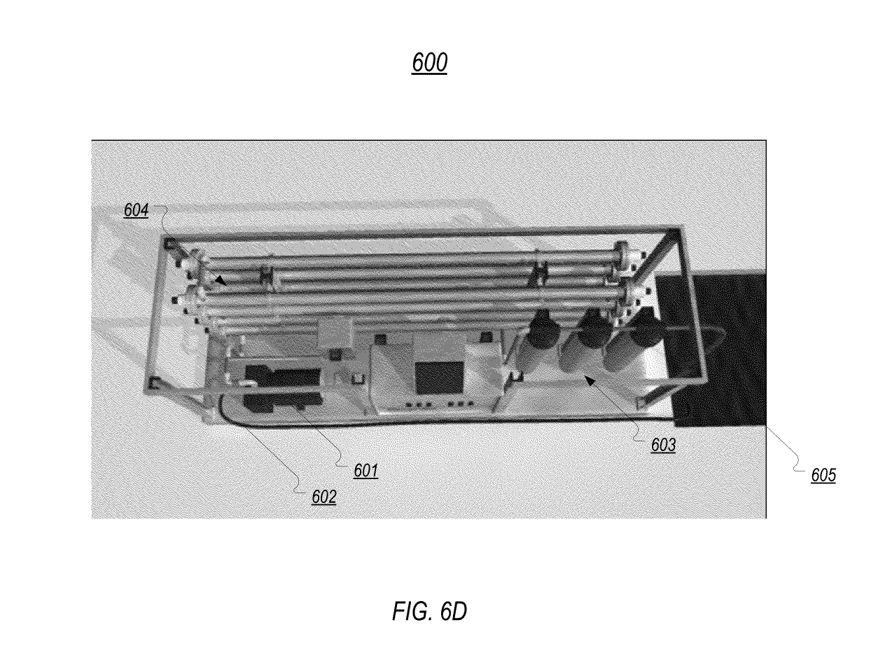

FIGS. 6A-6D each illustrate a different view of another example embodiment of a system 600 for removing ammonia from wastewater. As shown, system 600 includes an impeller pump 601, an input 602 that supplies wastewater from a wastewater source 605, an array of reactor tubes 604, and a post processing filtration unit 605. System 600 is an example where the output of the system is fed back into the wastewater source. As such, system 600 can represent using the present invention to decontaminate a wastewater source such as a lake, pond, or other body of water.

Using the System to Convert Ammonia to Nitrate

The above described system can also be used to convert ammonia into nitrate. To convert ammonia to nitrate, sodium hypochlorite (NaClO) or Calcium Hypochlorite (Ca(ClO)₂) can be added to the wastewater in place of the hypochlorite. Then, the wastewater can be treated at a rate that results in the ORP of the wastewater being less than 600 mV. At this ORP, the ammonia in the wastewater is in an oxidized form which is converted into nitrate according to the following equations:

2Cl⁻→Cl₂+2e⁻ (occurs at the anode during electrolysis) (1)

Cl2+H2O→HOCl+H⁺+Cl⁻ (2)

HOCl+(2/3NH₃→(1/3)N₂+H₂O+H⁺+Cl⁻ (3)

HOCl+(2/3)NH₄⁺→(1/3)N₂+H₂O+(5/3)H⁺+Cl⁻ (4)

HOCl+(1/4)NH₄⁺→(1/4)NO₃⁻+(1/4)H₂O+(3/2)H⁺+Cl^{—} (5)

HOCl+(1/2)OCl⁻→(1/2)ClO₃⁻+H⁺+Cl⁻ (6)

NH₃+H₂O+NaClO→NH₂+H₂O+NaCLO+H→NH⁺+H₂O+NaClO→NO₂⁻+8H⁺+NaClO (7)

NO₂⁻+H₂O+NaCl→NO₃⁻+2H⁺+NaCl (8)

It has been found that a current density of between 30-50 mA/cm² of the cathode is generally preferred to maximize the oxidation of the ammonia into nitrate and nitrite. However, other current densities can also be used, and the ideal density will depend on various characteristics such as the temperature of the wastewater.

In some embodiments, a nitrate rich broth containing desired metals (which may be used for fertilizer production) can be created by including the desired metals in the MMO coating of one or more of anodes 202. For example, one or more of iron, copper, manganese, molybdenum, zinc, or nickel can be added to an MMO coating. Similarly, one or more of the MMO coated anodes 202 can be replaced with a anode being coated with one or more desired metals. In a particular example, half of the reactor tubes 120 can include MMO coated anodes 202 and the other half of the reactor tubes 120 can include iron coated anodes.

Example Compositions of the Electrodes

The electrodes (i.e. cathode 201 and anode 202) can be made of a metal, composite, or other material known to impart conductivity, such as, but not limited to silver, copper, gold, aluminum, zinc, nickel, brass, bronze, iron, lead, platinum group metals, steel, stainless steel, carbon allotropes, and/or combinations thereof. Non-limiting examples of conductive carbon allotropes can include graphite, graphene, synthetic graphite, carbon fiber (iron reinforced), nano-carbon structures, and other form of deposited carbon on silicon substrates. In some configurations, the anode and/or the anode can serve as a sacrificial electrode which is used in the flocculation and/or bubble generation processes. As such, electrodes can include consumable conductive metals, such as iron or aluminum.

In some embodiments, anodes 202 can be comprised of a catalyst-coated metal such as iridium oxide coated titanium. Such metals can enhance the efficiency of the process. For example, by using iridium oxide coated titanium on the anode, the creation of gas bubbles containing chlorine (e.g. hypochlorite) can be facilitated.

Example Test Results

A first test was performed on wastewater that was used as live fish transport water and had become highly ammoniated. A system similar to system 500 shown in FIG. 5 was used to process the wastewater. For example, four 4′ long reactor tubes were connected in series with a feedback path connecting the output of the series of reactor tubes back to the input of the pump. Each reactor tube included a stainless steel outer cathode. Two of the reactor tubes (the first two in the series) included MMO anodes while the other two (the last two in the series) included iron anodes. The anodes in each reactor tube were centrally positioned with a 9 mm gap between the inner surface of the cathode and the outer surface of the anode.

A 15 GPM pump was used (e.g. as pump 103) and was driven at 14 GPM using a 12 volt power supply (requiring approximately 528 watts (528 W=8 V*66 A)). Because the wastewater already contained NaCl, no hypochlorite (or other chlorine based element) was added to the wastewater. A post processing filtration unit consisting of 2 GAC filters and 2 copper-zinc based filters (supplied by KDF Fluid Treatment of Three Rivers, Mich.) was used to remove hypochlorite from the processed wastewater.

The wastewater was treated for roughly 30 seconds. The wastewater was sampled at four points: (1) prior to being processed through the reactor tubes; (2) after being processed through the first two reactor tubes containing the MMO coated anodes; (3) after being processed through the last two reactor tubes containing the iron coated anodes; and (4) after being processed through the post processing filtration unit. The following tables list the readings for pH, ORP, conductivity, total dissolved solids (TDS), nitrate level, and ammonia level at these four points.

| | pH | ORP | Conductivity | TDS | Nitrate | Ammonia |
|---|---|---|---|---|---|---|
| At | 7.93 | 397 mV | 5287 μS | :4130 | +/−10 ppm | 9.98 mg/l |
| point 1 | | | | | | |

| | pH | ORP | Conductivity | TDS | Nitrate | Ammonia |
|---|---|---|---|---|---|---|
| At | 7.66 | 733 mV | 4869 μS | 3767 | +/−10 ppm | 1.5 mg/l |
| point 2 | | | | | | |

| | pH | ORP | Conductivity | TDS | Nitrate | Ammonia |
|---|---|---|---|---|---|---|
| At | 7.66 | 750 mV | 3888 μS | 2941 | +/−40 ppm | 0 mg/l |
| point 3 | | | | | | |

| | pH | ORP | Conductivity | TDS | Nitrate | Ammonia |
|---|---|---|---|---|---|---|
| At | 8.18 | 500 mV | 2552 μS | 1877 | +/−40 ppm | 0 mg/l |
| point 4 | | | | | | |

A second test was performed on wastewater obtained from the same source as in test one. However, the second test was performed using four reactor tubes that each contained a MMO anode (i.e. no iron anodes were used). Readings were made at two points: (1) prior to being processed through the reactor tubes; and (2) after being processed through the four reactor tubes but prior to passing through the post processing filtration unit. The following tables list the readings for pH, ORP, conductivity, total dissolved solids (TDS), nitrate level, and ammonia level at these two points.

| | pH | ORP | Conductivity | TDS | Nitrate | Ammonia |
|---|---|---|---|---|---|---|
| At | 7.93 | 397 mV | 5287 μS | :4130 | +/−10 ppm | 9.98 mg/l |
| point 1 | | | | | | |

| | pH | ORP | Conductivity | TDS | Nitrate | Ammonia |
|---|---|---|---|---|---|---|
| At point 2 | 7.93 | 750 mV | 4895 μS | 3767 | +/−0 ppm | 0 mg/l |

As shown in the tables above, after the wastewater had been processed through the reactor tubes, the ammonia level of the wastewater had reached 0. Also, the ORP at these points was 750 mV indicating the correlation between ORP and ammonia levels in wastewater.

Remediation of Other Contaminants from Wastewater

In addition to ammonia, the present invention can be employed to remove other contaminants from wastewater such as antibiotics, hormones, active inorganic chemicals (e.g. via reduction chemistry), and bacteria. Such contaminants can be removed from wastewater that also contains ammonia or that does not contain ammonia using the techniques described above. As wastewater containing such contaminants passes through the system of the present invention, the interaction of the chlorine based elements and/or the electric field with the contaminants causes them to break down into less harmful or harmless elements. Accordingly, wastewater treated using the techniques of the present invention can become more suitable for subsequent use such as for use as water for fisheries, for use as a growth medium (e.g. for algae or another useful organism), etc.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A system for removing ammonia from wastewater comprising:
a plurality of reactor tubes connected in series, each reactor tube comprising an outer cathode and an inner anode being positioned centrally within the outer cathode such that a spacing between 3 mm and 10 mm exists between the outer surface of the anode and the inner surface of the cathode, at least one of the reactor tubes containing an inner anode having a mixed metal oxide (MMO) coating;
a pump connected to an input of the plurality of reactor tubes, the pump receiving unprocessed wastewater containing ammonia from a wastewater source and pumping the unprocessed wastewater into and through the series of reactor tubes;
a power supply for supplying a voltage differential to the anode and the cathode in each reactor tube thereby causing the generation of chlorine based elements within the unprocessed wastewater as the unprocessed wastewater passes through the reactor tubes, wherein the chlorine based elements interact with the ammonia in the unprocessed wastewater to eliminate the ammonia thereby producing processed wastewater containing a reduced level of ammonia; and
a feedback path that diverts a portion of the processed wastewater that exits an output of the series of reactor tubes back to an input of the pump such that chlorine based elements contained in the processed wastewater are mixed with unprocessed wastewater to increase the level of chlorine based elements available in the unprocessed wastewater as the unprocessed wastewater passes through the reactor tubes.

2. The system of claim 1, further comprising:
a source of chlorine based elements that is connected to the input of the pump, the source of chlorine based elements supplying chlorine based elements to the unprocessed wastewater.

3. The system of claim 1, further comprising:
a filtration unit for filtering the chlorine based elements from the processed wastewater.

4. The system of claim 1, further comprising:
an ORP meter for measuring the ORP of the wastewater.

5. The system of claim 4, wherein the ORP meter is positioned to measure the ORP of the processed wastewater.

6. The system of claim 5, wherein the ORP meter outputs a signal for controlling one or more of:
an amount of chlorine based elements that are added to the unprocessed wastewater;
a rate at which the pump pumps wastewater through the reactor tubes;
a voltage level applied by the voltage source; or an amount of processed wastewater that is diverted back through the feedback path.

7. The system of claim 1, wherein the plurality of reactor tubes comprise at least four reactor tubes.

8. The system of claim 1, wherein each of the reactor tubes contains an inner anode having a MMO coating.

9. The system of claim 1, wherein the pump comprises an impeller pump which generated micron bubbles within the wastewater due to cavitation.

10. The system of claim 1, wherein the chlorine based elements are hypochlorite.

11. The system of claim 1, wherein one or more of the reactor tubes includes an inner anode having a coating containing one or more of iron, copper, manganese, molybdenum, zinc, or nickel.

12. The system of claim 1, further comprising:
a mixing chamber positioned after the pump and before the reactor tubes, wherein the chlorine based elements supplied through the feedback path are mixed with the unprocessed wastewater in the mixing chamber.

13. The system of claim 1, wherein an output of the reactor tubes supplies the processed wastewater back to the source of the unprocessed wastewater.

14. The system of claim 1, wherein the processed wastewater contains nitrates generated from the ammonia.

15. A method for removing ammonia from wastewater comprising:
receiving unprocessed wastewater at a pump connected to a series of interconnected reactor tubes, each reactor tube comprising an outer cathode and an inner anode being positioned centrally within the outer cathode such that a spacing between 3 mm and 10 mm exists between the outer surface of the anode and the inner surface of the cathode, at least one of the reactor tubes containing an inner cathode having a mixed metal oxide (MMO) coating;
injecting chlorine based elements to the unprocessed wastewater;
pumping the unprocessed wastewater containing the chlorine based elements through the reactor tubes;
applying a voltage differential to the anode and cathode of each reactor tube to cause an interaction between the MMO coating and the chlorine based elements which produces additional chlorine based elements, the chlorine based elements interacting with the ammonia to reduce the amounts of ammonia in the wastewater thereby producing processed wastewater; and
diverting a portion of the processed wastewater from an output of the series of interconnected reactor tubes, the portion of the processed wastewater being diverted to an input to the pump such that chlorine based elements contained in the portion of the processed wastewater are supplied into unprocessed wastewater that is pumped into the series of interconnected reactor tubes.

16. The method of claim 15, further comprising:
monitoring an oxidizing reduction potential (ORP) of the processed wastewater.

17. The method of claim 16, wherein monitoring the ORP of the processed wastewater comprises one or more of:
identifying when the ORP of the processed wastewater has reached 750 mV; or identifying when the ORP is approaching 600 mV.

18. The method of claim 17, further comprising:
adapting an amount of chlorine based elements that are injected into the unprocessed wastewater to cause the processed wastewater to reach a desired ORP upon being output from the series of interconnected reactor tubes;
wherein the desired ORP is 750 mV when it is desired that the ammonia be completely removed from the processed wastewater; and
wherein the desired ORP is 600 mV when it is desired that a substantial portion of the ammonia be removed from the processed wastewater and a substantial portion of nitrates remain in the processed wastewater.

19. The method of claim 15, further comprising:
supplying the processed wastewater output from the series of interconnected reactor tubes to a filtration unit configured to remove the chlorine based elements from the processed wastewater.

20. A system for removing ammonia from wastewater comprising:
a plurality of reactor tubes connected in series, each reactor tube comprising an outer cathode and an inner cathode being positioned centrally within the outer cathode such that a spacing between 3 mm and 10 mm exists between the outer surface of the cathode and the inner surface of the cathode, at least one of the reactor tubes containing an inner cathode having a mixed metal oxide (MMO) coating;
a hypochlorite source for injecting hypochlorite into unprocessed wastewater containing ammonia;
a pump connected to an input of the plurality of reactor tubes, the pump receiving the unprocessed wastewater and pumping the unprocessed wastewater into and through the series of reactor tubes, wherein the pump causes cavitation to occur within the unprocessed wastewater, the cavitation increasing the mixing of the hypochlorite within the unprocessed wastewater;
a power supply for supplying a voltage differential to the cathode and the cathode in each reactor tube, the voltage differential causing the release of chlorine from the at least one MMO coated inner cathode that interacts with the hypochlorite to produce additional hypochlorite, wherein the hypochlorite interacts with the ammonia in the unprocessed wastewater to eliminate the ammonia thereby producing processed wastewater containing a reduced level of ammonia; and
a feedback path that diverts a portion of the processed wastewater that exits an output of the series of reactor tubes back to an input of the pump such that hypochlorite contained in the processed wastewater is mixed with unprocessed wastewater to increase the level of hypochlorite available in the unprocessed wastewater as the unprocessed wastewater passes through the reactor tubes.
